(19) United States
(12) Patent Application Publication
(10) Pub. No.: US 2009/0188748 A1
(43) Pub. Date: Jul. 30, 2009

(54) NOISE SUPPRESSION PANELS AND REPAIR METHODS THEREFOR

(75) Inventors: James F. Stevenson, Morristown, NJ (US); Roger B. Williamson, Flanders, NJ (US); Ion Virgil Vintilescu, Phoenix, AZ (US); Vincent Chung, Tempe, AZ (US); Martin C. Baker, Budd Lake, NJ (US); Lee Poandl, Middlesex, NJ (US)

Correspondence Address: HONEYWELL INTERNATIONAL INC.;PATENT SERVICES, 101 COLUMBIA ROAD, P O BOX 2245, MORRISTOWN, NJ, 07962-2245, US

(73) Assignee: Honeywell International Inc., Morristown, NJ (US)

(21) Appl. No.: 12/019,124

(22) Filed: Jan. 24, 2008

(51) Int. Cl. E04B 1/84; B23P 6/00

(52) U.S. Cl. 181/294; 29/402.08

(57) ABSTRACT

Methods are provided for repairing a defect in a noise suppression panel. In an embodiment, by way of example only, a method includes the steps of removing a section of the noise suppression panel that includes the defect to thereby create a cavity, forming an insert configured to mate with the cavity, the insert comprising an acoustic damping material comprising a plurality of fibers and a binder, and placing the insert within the cavity.

### TECHNICAL FIELD

The inventive subject matter relates to noise suppression panels and, more particularly, to noise suppression panels for aircraft ducts and plenums, and methods of repairing the panels.

### BACKGROUND

Many aircraft are powered by jet engines. In most instances, jet engines include one or more gas-powered turbine engines and auxiliary power units (APUs) which can generate both thrust to propel the aircraft and electrical energy to power systems installed in the aircraft. Although most aircraft engines are generally safe, reliable, and efficient, the engines do exhibit certain drawbacks. For example, the turbine engines, as well as other components that make up the engine, can be sources of unwanted noise, especially during aircraft take-off and landing operations. Moreover, APUs can be sources of unwanted ramp noise. Thus, various governmental rules and regulations aimed at mitigating such noise sources have been enacted.

To address, and at least somewhat alleviate, the unwanted noise emanating from aircraft noise sources, and to thereby comply with the above-noted rules and regulations, various types of noise reduction treatments have been developed. For example, one type of noise reduction treatment that has been developed for use in aircraft ducts is a noise suppression panel. In many instances, noise suppression panels are flat or contoured, and include a bulk absorber, such as a honeycomb material, disposed between a backing plate and a face plate. Other materials and structures may also be disposed between the backing plate and face plate. The noise suppression panels are typically placed on the interior surface of engine or APU inlet and/or outlet plenums, as necessary, to reduce noise emanations.

Periodically, these noise suppression panels or sections thereof may become worn or damaged. Voids may form in the bulk absorber, or alternatively, air gaps may appear between the face plate and the bulk absorber. In other cases, the face plate forming the top surface of the bulk absorber may be dented or broken. Conventionally, the repair of these sections include, for example, applying liquid resin to the voids or air gaps and subsequent curing of the noise suppression panel. Other repair methods have included filling the voids or sections with a clay-like substance. However, neither cured resins nor clay have acoustic damping properties, and thus, can reduce, rather than maintain or enhance, the noise suppression capabilities of the panel. In some cases, voids and/or contamination may appear in the bulk absorber during manufacture or use of the noise suppression panels. In such cases, the panels may not operate as intended, and thus may be entirely discarded during the manufacturing process. As a result, the costs of aircraft manufacture and/or maintenance may increase.

Hence, there is a need for a method of repairing a noise suppression panel that restores the noise suppression capabilities of the panel to its original specifications, and/or is less costly compared to known methods, and/or maintains noise suppression capabilities over a relatively wide frequency range. The inventive subject matter addresses one or more of these needs.

### BRIEF SUMMARY

Methods are provided for repairing a defect in a noise suppression panel.

In one embodiment, and by way of example only, a method includes removing a section of the noise suppression panel that includes the defect to thereby create a cavity. The method may also include forming an insert configured to mate with the cavity, the insert comprising an acoustic damping material comprising a plurality of fibers and a binder. The method may further include placing the insert at least partially within the cavity.

In another embodiment, by way of example only, a method is provided for repairing a defect in a noise suppression panel having a back plate, a face plate and a bulk absorber disposed therebetween. The method includes removing at least a portion of the face plate. Then, a section of the bulk absorber that includes the defect is removed to thereby create a cavity. An insert configured to mate with the cavity is formed, the insert comprising an acoustic damping material comprising a plurality of fibers and a binder. The insert is the placed into the cavity. The bulk absorber is bonded to the back plate.

In still another embodiment, by way of example only, a repaired noise suppression panel is provided. The panel includes a back plate, a face plate, and a bulk absorber disposed between the back plate and the face plate. The bulk absorber includes a cavity formed therein and an insert disposed in the cavity, where the insert comprises an acoustic damping material comprising a plurality of fibers and a binder.

Other independent features and advantages of the method and repaired noise suppression panel will become apparent from the following detailed description, taken in conjunction with the accompanying drawings which illustrate, by way of example, the principles of the inventive subject matter.

### BRIEF DESCRIPTION OF THE DRAWINGS

FIG. 1 is a simplified cutaway view of a noise suppression panel according to an embodiment;

FIG. 2 is a perspective view of a damaged noise suppression panel, according to an embodiment;

FIG. 3 is a flowchart of a process for repairing the noise suppression panel of FIGS. 1-3, according to an embodiment;

FIG. 4 is a simplified representation of one step of a process for repairing the noise suppression panel of FIGS. 1-3, according to an embodiment;

FIG. 5 is a simplified representation of another step of the process for repairing the noise suppression panel of FIGS. 1-3, according to an embodiment;

FIGS. 5A and 5B are cross-sectional views of the noise suppression panel illustrated in FIG. 5 taken along lines 5A, 5B-5A, 5B, according to an embodiment;

FIG. 6 is a simplified cross-sectional view of a bulk absorber and an insert during a step of the process for repairing the noise suppression panel of FIGS. 1-3, according to an embodiment; and

FIG. 7 is a simplified cross-sectional view of a bulk absorber and an insert during a step of the process for repairing the noise suppression panel of FIGS. 1-3, according to an embodiment.

### DETAILED DESCRIPTION

Before proceeding with the detailed description, it is to be appreciated that the described embodiment is not limited to use in conjunction with a particular type of engine, or in a particular type of vehicle. Thus, although the present embodiment is, for convenience of explanation, described as being implemented in an aircraft environment, it will be appreciated that it can be implemented in various other types of vehicles, and in various other systems and environments.

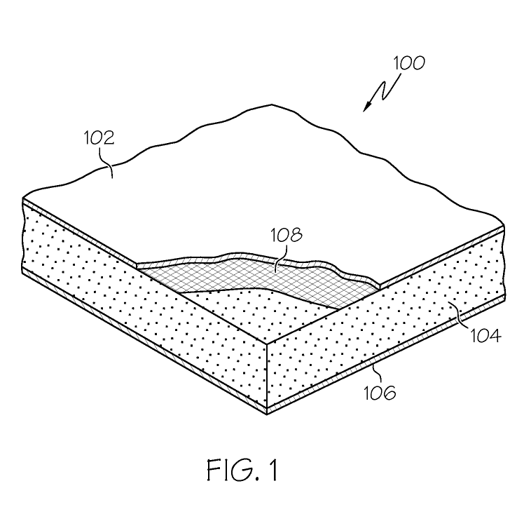

FIG. 1 is a cutaway view of a noise suppression panel 100, according to an embodiment. The noise suppression panel 100 is configured to reduce noise by blocking transmission of selected acoustic frequencies. For example, the noise suppression panel 100 may block frequencies between about 500 Hz and about 20,000 Hz. In other embodiments, the noise suppression panel 100 may block frequencies that are less than or greater than the frequencies in the aforementioned range. In any case, the noise suppression panel 100 may include a face plate 102, a bulk absorber 104, and a back plate 106, in an embodiment.

The face plate 102 is configured to receive an initial transmission of sound during panel operation and to be acoustically transparent to any incident sound. In this regard, the face plate 102 may be perforated to a desired percent open area (POA) value. As is generally known, relatively low POA values (e.g., ˜5%) provide acoustic resistance, whereas relatively high POA values (e.g., >30%) provide acoustic transparency. Thus, in a particular embodiment, the face plate 102 may be perforated to a POA value greater than about 30%. The face plate 102 may be constructed of any one of numerous types of materials suitable for maintaining structural integrity, while having the desired POA value, such as, for example, aluminum, carbon composites, or bismaleimide. In another embodiment, the face plate 102 may be a screen. In an embodiment, the face plate 102 may have a thickness of between about 0.6 mm and about 0.8 mm. In other embodiments, the face plate 102 may be thicker or thinner.

The bulk absorber 104 is configured to receive and acoustically damp sound that is transmitted through the face plate 102 and may be disposed between the face plate 102 and back plate 106. In an embodiment, the bulk absorber 104 may lay loosely between the two plates 102, 106. In another embodiment, the bulk absorber 104 may be directly bonded to the back plate 106.

To provide a desired acoustic damping capability, the bulk absorber 104 may be constructed of any one of numerous types of suitable acoustic damping materials. In one embodiment, the acoustic damping material may comprise a foamable material. In another embodiment, the acoustic damping material may comprise a plurality of fibers and a binder. For example, the acoustic damping material may comprise a random network of microfibers that is loosely held together by the binder. The network of microfibers may comprise one or more types of microfibers, in an embodiment. For instance, the microfibers may comprise two types of microfibers. In an embodiment, the two types of microfibers may be reinforcement microfibers and fibrillated microfibers.

As used herein, the term “reinforcement microfibers” refer to microfibers having a length of between about 0.5 and 7.5 cm, that are relatively straight, have an average diameter of between about 5.5 microns and about 18 microns, and have a modulus greater than about 75 GPa. Reinforcement microfibers, when bonded to each other with a binder, provide mechanical integrity and/or resistance to deformation to the acoustic damping material. In one embodiment, the reinforcement microfibers include carbon-based microfibers. For example, polyacrylonitrile (PAN)-based carbon microfibers may be used. Suitable PAN-based carbon microfibers include Thornel® T-300 PAN microfibers available through Cytec Industries, Inc. of West Paterson, N.J. The average diameter of such carbon-based microfibers is between about 5.5 microns to about 9.5 microns. In another embodiment, the reinforcement microfibers include glass microfibers. In still another embodiment, the reinforcement microfibers include basalt microfibers. An example of a suitable basalt microfiber is provided under the tradename Sudaglass® and is available through Sudaglass Fiber Technology, Inc. of Houston, Tex. The average diameter of the basalt reinforcement fibers is within a range of between about 12 microns to about 18 microns.

The reinforcement microfibers may be made up of a single type of microfiber (e.g., carbon-based, glass, basalt, etc.), in an embodiment. In other embodiments, the reinforcement microfibers may be made up of a mixture of two or more microfiber types.

The term “fibrillated microfibers” may be defined as microfibers having a length of between about 0.2 mm and 5.0 mm and an average diameter of between about 1 and to more than 20 microns. Fibrillated microfibers may be curved and branched along their lengths and have many fibrils that may be as small as about 0.1 micron, in an embodiment. In other embodiments, the fibrils may be smaller than or larger than 0.1 micron. The fibrillated microfibers may be capable of intertwining with reinforcement microfibers. Because the fibrillated microfibers generally have a smaller diameter and are more highly branched and contoured than the reinforcement microfibers, a volume of fibrillated microfibers provides a higher resistance to air flow when compared to an equal volume of reinforcement microfibers. Additionally, when fibrillated microfibers are mixed with reinforcement microfibers, a network consisting of the combined microfibers is formed where the two types of microfibers are randomly disposed without any particular orientation.

Several fibrillated microfibers having the aforementioned properties may be employed. In one embodiment, the fibrillated microfibers are fibrillated aramid microfibers. The fibrillated aramid microfibers, also known in the art as fibrillated poly (aromatic amide) microfibers, are capable of maintaining integrity when subjected to temperatures of at least 280° C. and are available from E.I. DuPont de Nemours of Delaware under the tradename Kevlar® pulp. The diameters of fibrillated aramid may be between about 0.5 microns to more than 20 microns. Another suitable fibrillated microfiber is, as an example, acrylic pulp. The fibrillated microfibers may be made up of a single type of microfiber, in an embodiment. In other embodiments, the fibrillated microfibers may be made up of a mixture of two or more microfiber types.

As mentioned above, the acoustic damping material may include a binder. In an embodiment, the binder may be a phenolic or an epoxy powder. When used to bind a mass containing reinforcement and fibrillated microfibers, powder may improve uniformity and increase the porosity of the mass. Suitable thermoset polymer binders include, but are not limited to Durite® binders AD-3239 or AD-5614 available through Hexion Specialty Chemicals of Columbus, Ohio or U-Nyte™ Set 201 epoxy powder binder available through Hydrosize® Technologies of Raleigh, N.C. In still another embodiment, the binder may be a thermoplastic powder binder that may include, for example, polyvinyl chloride or polyethylene.

To suitably damp noise, the acoustic damping material may include the microfibers and binder at a particular ratio. For example, the reinforcement microfibers and the fibrillated microfibers may make up a mixture where the two types of microfibers are present at a ratio of between about 1:1 and about 15:1, by weight. In an embodiment, the binder may be added to the mixture such that is included at a ratio of between about 0.20:1 to about 1.5:1, by weight. Consequently, the acoustic damping material may include between about 0% and about 25% by weight of fibrillated microfibers, between about 20% and about 75% by weight of reinforcement microfibers, and between about 15% and about 60% by weight of the binder. Generally, such ratios may form an acoustic damping material having a volume fraction solids value of between about 1.5% to about 5.5%. A volume fraction solids value indicates a percent of a volume of the material that is made up of a solid as compared to a percent of the volume of the material that is made up of air. It will be appreciated that in other embodiments, the ratio of fibrillated microfiber to reinforcement microfiber and the ratio of binder to microfiber mixture may be more or may be less. In some embodiments, the ratio may be 0. Accordingly, more or less fibrillated microfibers, reinforcement microfibers, and/or binder may be employed in other embodiments.

In any case, the bulk absorber 104 may be present at a thickness of between about 6 mm and about 32 mm. In other embodiments, the bulk absorber 104 may be thicker or thinner.

To protect the bulk absorber 104 from fluids, an intermediate layer 108 may be included thereover, as shown in FIG. 1. In such an embodiment, the intermediate layer 108 may be disposed between the face plate 102 and the bulk absorber 104 and may be made of any one of numerous fluid repelling materials. For example, the intermediate layer 108 may be made of polyetheretherketone or a fluoropolymer, such as Teflon® available through E.I. DuPont de Nemours of Delaware. In other embodiments, the intermediate layer 108 may be a fine screen or mesh having between about a 40×40 mesh and a 120×120 mesh, and being made of a metallic material, such as aluminum. The mesh may be coated or treated with a low surface energy coating, such as a fluoropolymer. Suitable fluoropolymers include, but are not limited to, a fluorine based plasma treatment, available thorough P2i of Abingdon, UK.

In any case, the back plate 106 provides structure to the noise suppression panel 100 and may receive damped acoustic frequencies from the bulk absorber 104. In this regard, the back plate 106 may be disposed adjacent to the bulk absorber 104 and as mentioned above, may be bonded directly to the bulk absorber 104 in some embodiments. The back plate 106 may be imperforate and may be constructed of any one of numerous types of non-porous materials such as, for example, aluminum, epoxy, or bismaleimide (BMI). The back plate 106 may have a thickness of between about 0.0.5 mm and about 0.75 mm, in an embodiment. In other embodiments, the back plate 106 may be thicker or thinner.

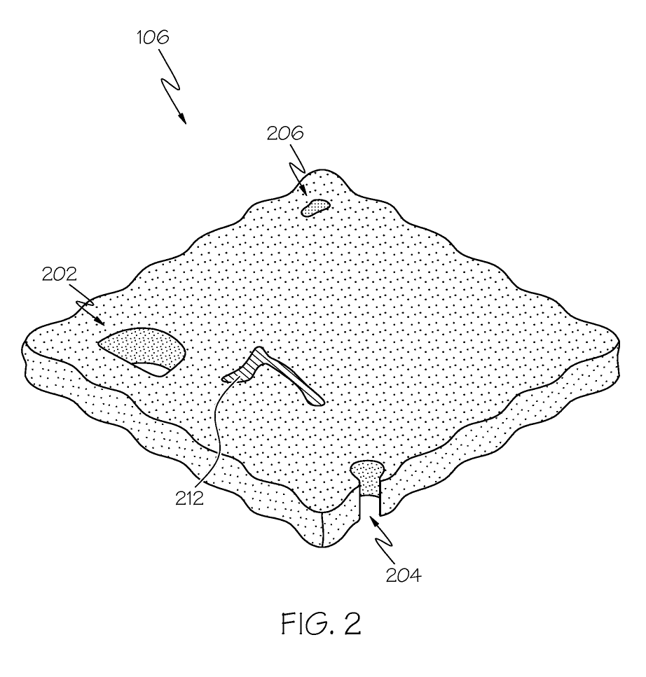

During manufacture or as a result of normal wear or contamination by fluids or solids, the noise suppression panel 100, in particular, the bulk absorber 104 may become damaged or defective. The damage may take any one of numerous forms. FIG. 2 is a perspective view of a portion of a bulk absorber 200, including damage, according to an embodiment. The bulk absorber 200 may include a void 202 that adversely affects the noise suppression capabilities of the noise suppression panel 100. The void 202 may extend partially or entirely through the thickness of the bulk absorber 200. In another example, the defect may be a shallow depression at the surface of the bulk absorber 200. This type of defect may result from incomplete filling of the panel during the manufacturing process. In still another example, the defect may be a density defect 206, which may result when the density of one section is higher or lower than desired. In still yet another example, excess epoxy adhesive may leak into and solidify in the bulk absorber 200 during manufacture to form a solid contamination 212. It will be appreciated that although the void 202 and the density defect 206 are illustrated as being at certain locations on the bulk absorber 200, they may occur at other locations on the bulk absorber 200. For instance, either may be present on the edge of the bulk absorber 200, such as void 204 illustrated in FIG. 2.

In other cases, the back plate 106 and/or face plate 102 may be damaged. In still another example, damage may result from the ingress of fluids such as hydraulic fluid, known as Skydrol™ (available through Solutia, Inc. of Houston, Tex.), jet fuel, or aircraft deicing solution. If the fluid does not drain or evaporate, it may affect a region of the back plate 106 and/or face plate 102, which may then need to be replaced. In still yet another example, the face plate 102 may pull apart from the bulk absorber 104.

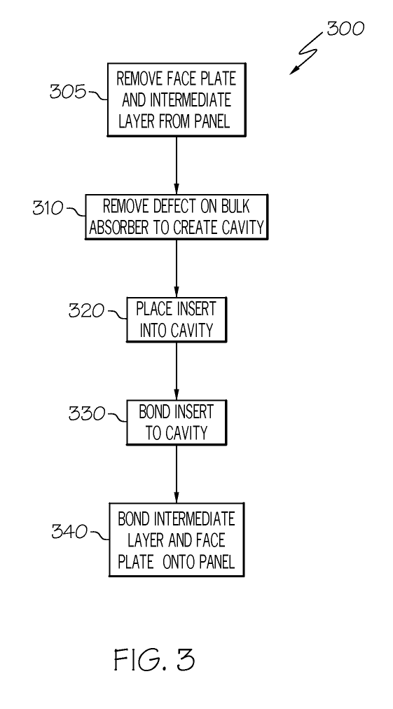

Regardless of the particular type of defect in the bulk absorber 200, the noise suppression panel 100 may be repaired using process 300, depicted in a flow diagram in FIG. 3. In an embodiment, a section of a noise suppression panel is removed to expose a damaged area of a bulk absorber step 305. Then, a defect on the bulk absorber is removed to create a cavity, step 310. Next, an insert is placed into the cavity, step 320. The insert is bonded to the cavity, step 330. A face plate and intermediate layer may be replaced to thereby complete formation of a repaired noise suppression panel, step 340. These steps will now be discussed in detail below.

As briefly mentioned previously, a section of a noise suppression panel is removed to expose a damaged area of a bulk absorber step 305. In an embodiment, a portion or substantially all of a face plate of the noise suppression panel is removed. In an embodiment in which the noise suppression panel includes an intermediate layer, a portion or an entirety of the intermediate layer may be removed as well.

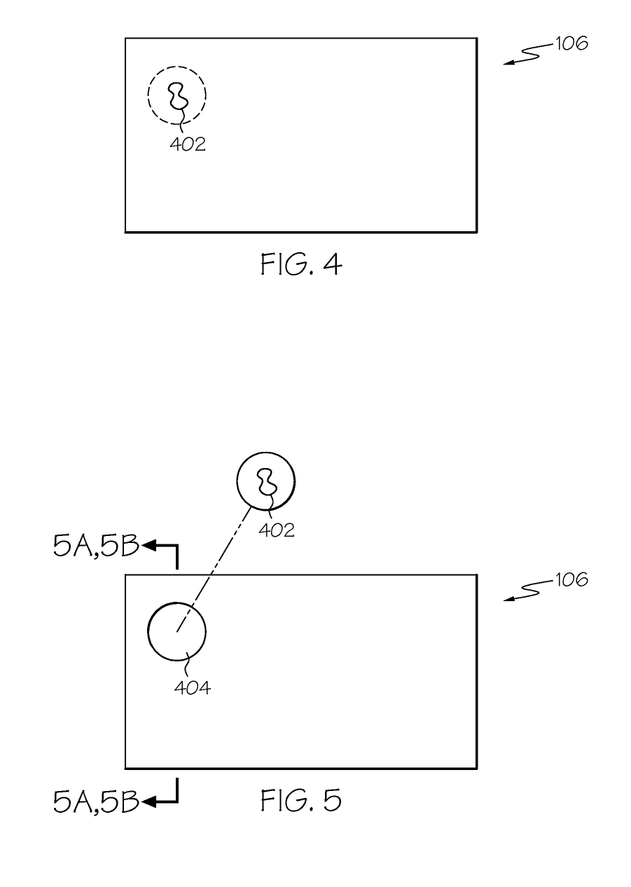

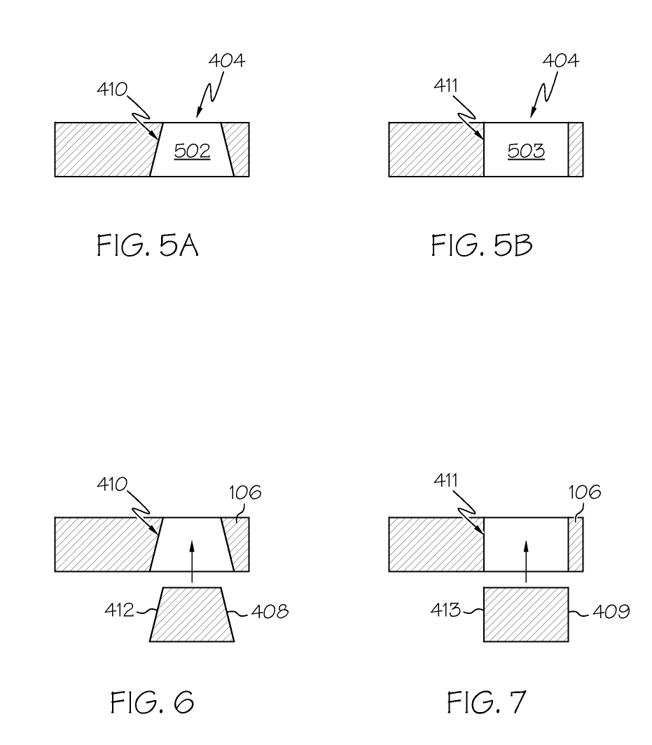

Next, a defect is removed from the bulk absorber to create a cavity, step 310. In an embodiment, with reference to FIG. 4, a defect 402 is first identified on a bulk absorber 406. Next, a portion of the bulk absorber 406 including the defect 402 is removed, as shown in FIG. 5. The removed portion leaves a cavity 404 in the bulk absorber 406. In an embodiment, the cavity 404 may be sized larger than the defect 402 and may be created in any one of numerous manners. In one embodiment, the cavity 404 is created using an ultrasonic knife or industrial cutting scissors. In another embodiment, the cavity 404 can be formed using a sharp-edged hollow punch. In still another embodiment, such as in an embodiment in which the bulk absorber 406 comprises carbon fibers or basalt fibers, the cavity 404 may be formed using a high-speed abrasive cutting wheel. In any case, the cavity 404 is formed such that a selected shape is formed in the bulk absorber 406. For example, the selected shape may be defined by cavity walls 411 that form a truncated cone 502, as shown in FIG. 5A, or in another embodiment, the selected shape may be defined by cavity walls 411 that form a cylinder 503, as shown in FIG. 5B.

After the defect 402 is removed, an insert can then be placed into the cavity 404, step 320. In one embodiment, the insert may be formed before placement into the cavity 404. The insert may be made from acoustic damping material and can be formed by any one of numerous methods. Some examples include, but are not limited to cutting the insert out of a block of acoustic damping material. For example, the insert may be cut using an ultrasonic knife, industrial cutting scissors, a shearing edge tool, a high-speed abrasive cutting wheel or other cutting tool. In another example, the insert may be shaped by placing loose fibers and a binder in a container. Suitable loose fibers and binders include those mentioned above that make up acoustic damping materials.

The acoustic damping material from which the insert may be made may be any one of a number of materials that can damp noise. In an embodiment, the acoustic damping material from which the insert may be made may be selected for ability to damp aircraft noise by between about 5 and 10 dB. In another embodiment, the acoustic damping material may be selected for meeting federal noise level standards mandated by the Federal Aviation Administration. Examples of suitable materials include but are not limited to, the acoustic damping materials mentioned above that may be used to form the bulk absorber 104 (FIG. 1). Additional materials include, but are not limited to those materials disclosed in U.S. patent application Ser. No. 10/851,974 entitled “Noise Suppression Structure Manufacturing Method” filed on May 20, 2004, and U.S. patent application Ser. No. 10/783,555 entitled “Noise Suppression Structure and Method of Making Same” filed on Feb. 20, 2004. In an embodiment, the acoustic damping material from which the insert may be made has mechanical properties that are at least comparable to those of the bulk absorber material to maintain the mechanical integrity of the bulk absorber. Thus, the acoustic damping material from which the insert may be made may be the same material from which the bulk absorber is manufactured, in an embodiment. In other embodiments, the acoustic damping material from which the insert may be made and the bulk absorber may not be the same material.

After the insert is formed, it is placed into the cavity 404. As shown in FIGS. 6 and 7, an insert 408, 409 may be placed at least partially within the cavity 404. For example, the insert 408, 409 may be sized larger than the cavity and only a portion of the insert 408, 409 inserted into the cavity 404. In another embodiment, the insert 408, 409 is placed such that the cavity walls 410, 411 and insert walls 412, 413 mate with one another. In some embodiments, and as was mentioned above, the cavity walls 410 and insert walls 412, each have conical or cylindrical shapes that mate with one another and mechanically lock the insert 408, 409 into the cavity 404, such as illustrated in FIGS. 6 and 7.

At some point during step 320, the insert 408, 409 may be cured. Curing may be employed to increase a structural integrity of the insert 408, 409, especially if the insert 408, 409 includes a binder therein. In an embodiment, the insert 408, 409 may be cured while it is formed. In another embodiment, curing may occur after the insert 408, 409 is formed. In still another embodiment, the insert 408, 409 may be cured after it is placed into the cavity 404.

In some cases, to ensure the insert 408,409 remains in a particular position, the insert 408, 409 is bonded to the cavity 404, step 330. Any bonding method and bonding agent suitable for use with the acoustic damping materials from which the insert is made and the materials making up the bulk absorber may be implemented. For example, a bonding agent, such as any one of numerous glues, epoxies, silicone adhesives, or ceramic cements may be applied as an aerosol spray, liquid, or powder to the cavity walls 410, 411, insert walls 412, 413, or both. The insert 408, 409 and cavity 404 are aligned and brought into contact with one another. In another embodiment, bonding may be employed in conjunction with mechanically locking the insert 408 into the cavity 404.

Finally, the face plate and intermediate layer may be replaced to thereby complete formation of the repaired noise suppression panel, step 340. In an embodiment in which the face plate and intermediate layer are undamaged, the two may be replaced in a manner similar to their original method of manufacture. If either the face plate or intermediate layer is damaged, the damaged portions thereof are removed and corresponding cutouts are formed from the materials of which the face plate or intermediate layer are made. The cutouts may be larger than the damaged portions of the face plate and/or intermediate layer and may be bonded onto adjacent, undamaged portions of the face plate or intermediate layer in their respective locations.

Processes have now been provided for repairing defects on a noise suppression panel that may be improved over conventional repair processes. In particular, by using acoustic damping materials, such as those including a plurality of fibers and a binder, the noise suppression capabilities of defective panels may be restored to original specifications. The processes above may be less costly to implement as compared to known methods, and/or may restore noise suppression capabilities of the panels over a relatively wide frequency range.

While the inventive subject matter has been described with reference to an exemplary embodiment, it will be understood by those skilled in the art that various changes may be made and equivalents may be substituted for elements thereof without departing from the scope of the inventive subject matter. In addition, many modifications may be made to adapt to a particular situation or material to the teachings of the inventive subject matter without departing from the essential scope thereof. Therefore, it is intended that the inventive subject matter not be limited to the particular embodiment disclosed as the best mode contemplated for carrying out this inventive subject matter, but that the inventive subject matter will include all embodiments falling within the scope of the appended claims.

We claim:

1. A method for repairing a defect in a noise suppression panel, the method comprising:
removing a section of the noise suppression panel that includes the defect to thereby create a cavity;
forming an insert configured to mate with the cavity, the insert comprising an acoustic damping material comprising a plurality of fibers and a binder; and
placing the insert at least partially within the cavity.

2. The method of claim 1, wherein the cavity and the insert each have a sidewall and the method further comprises:
applying a bonding agent to at least one of the sidewalls; and
adhering the insert sidewall and cavity sidewall to one another.

3. The method of claim 2, wherein the bonding agent comprises a material selected from the group consisting of epoxy, silicone adhesive, and ceramic cement.

4. The method of claim 1, wherein the step of forming an insert comprises forming an insert from acoustic damping material having fibers comprising reinforcement microfibers and fibrillated microfibers.

5. The method of claim 4, wherein the reinforcement microfibers comprise microfibers selected from the group consisting of carbon-based microfibers, glass microfibers, and basalt microfibers.

6. The method of claim 4, wherein the fibrillated microfibers comprise microfibers selected from the group consisting of acrylic pulp and poly (aromatic amide) microfibers.

7. The method of claim 1, wherein the binder comprises a material selected from the group consisting of a phenolic, a thermoset polymer, a thermoplastic, a glass, and a ceramic.

8. The method of claim 1, wherein the step of forming an insert comprises forming an insert from acoustic damping material having fibers comprising between about 0% and about 25% by weight of fibrillated microfibers, between about 20% and about 75% by weight of reinforcement microfibers, and between about 15% and about 60% by weight of the binder.

9. The method of claim 1, wherein the noise suppression panel and the acoustic damping material comprise the same material.

10. The method of claim 1, wherein the noise suppression panel and the acoustic damping material comprise different materials.

11. The method of claim 1, further comprising:
bonding a back plate or a face plate to the noise suppression panel.

12. A method for repairing a defect in a noise suppression panel having a back plate, a face plate, and a bulk absorber disposed therebetween, the method comprising:
removing at least a portion of the face plate;
removing a section of the bulk absorber that includes the defect to thereby create a cavity;
forming an insert configured to mate with the cavity, the insert comprising an acoustic damping material comprising a plurality of fibers and a binder;
placing the insert into the cavity; and
bonding the bulk absorber to the back plate.

13. The method of claim 12, wherein the step of forming an insert comprises forming an insert from acoustic damping material having fibers comprising reinforcement microfibers and fibrillated microfibers.

14. The method of claim 13, wherein the reinforcement microfibers comprise microfibers selected from the group consisting of carbon-based microfibers, glass microfibers, and basalt microfibers.

15. The method of claim 13, wherein the fibrillated microfibers comprise microfibers selected from the group consisting of acrylic pulp and poly (aromatic amide) microfibers.

16. The method of claim 12, wherein the step of forming an insert comprises cutting the acoustic damping material using a tool selected from the group consisting of an ultrasonic knife, industrial cutting scissors, sharp-edged hollow punch and, a high-speed abrasive cutting wheel.

17. The method of claim 12, wherein the noise suppression panel and the acoustic damping material comprise the same material.

18. The method of claim 12, wherein the noise suppression panel and the acoustic damping material comprise different materials.

19. A repaired noise suppression panel comprising:
a back plate;
a face plate; and
a bulk absorber disposed between the back plate and the face plate, the bulk absorber including a cavity formed therein and an insert disposed in the cavity, the insert comprising an acoustic damping material comprising a plurality of fibers and a binder.

20. The repaired noise suppression panel of claim 19, wherein the acoustic damping material further comprises:
reinforcement microfibers comprising microfibers selected from the group consisting of carbon-based microfibers, glass microfibers, and basalt microfibers;
fibrillated microfibers comprising microfibers selected from the group consisting of acrylic pulp and poly (aromatic amide) microfibers; and
a binder comprising a material selected from the group consisting of a phenolic, a thermoset polymer, a thermoplastic, a glass, and a ceramic.
